(19) United States
(12) Patent Application Publication
(10) Pub. No.: US 2006/0124698 A1
(43) Pub. Date: Jun. 15, 2006

(54) Device, and associated method, for coupling trusses together

(76) Inventor: Jack W. Hawthorne JR., Yantis, TX (US)

Correspondence Address: SCHEEF & STONE, L.L.P., 5956 SHERRY LANE, SUITE 1400, DALLAS, TX, 75225, US

(21) Appl. No.: 11/184,041

(22) Filed: Nov. 29, 2004

(51) Int. Cl. A47J 36/02

(52) U.S. Cl. 228/101

(57) ABSTRACT

A first truss may be coupled to a second truss by securing a male coupling portion of a coupling device to the first truss, and securing a female portion of the coupling device to the second truss. An extension of the male coupling portion is positioned within an opening of the female coupling portion. The extension is provided with a groove, and the female coupling portion is provided with a lever having a cam formed on it, such that the level may be rotated causing the cam to engage the groove and secure the male coupling portion to the female coupling portion, thereby securing together the first and second trusses.

### TECHNICAL FIELD

The invention relates generally to mechanical couplings and, more particularly, to a mechanical device, and associated method, adapted for coupling together two truss structures.

### BACKGROUND

Truss structures that are assembled for temporary purposes, as is common in the theatrical and entertainment industry, are typically coupled together using conventional bolt and nut fasteners, or forkend/spigotted connectors. A drawback with such techniques is that, due to the large number of joints that must be coupled together in a typical structure, it is generally very time-consuming, and hence very costly, to assemble such a structure. Furthermore, since such structures are, by their nature, temporary and must typically be disassembled a relatively short period of time subsequent to being assembled, substantial time must also be invested to decouple all such truss structures.

Thus, the need has arisen for devices and methods adapted for quickly and readily coupling together and decoupling truss structures.

### SUMMARY

The present invention, accordingly, provides a coupling device wherein a first truss may be coupled to a second truss by securing a male coupling portion of the coupling device to the first truss, and securing a female portion of the coupling device to the second truss. An extension of the male coupling portion is positioned within an opening of the female coupling portion. The extension is provided with a groove, and the female coupling portion is provided with a lever having a cam formed on it, such that the level may be rotated causing the cam to engage the groove and secure the male coupling portion to the female coupling portion, thereby securing together the first and second trusses.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of two truss structures coupled together using coupling devices embodying features of the present invention;

FIG. 2 is a perspective view of the two truss structures of FIG. 1 decoupled from each other;

FIG. 3 is an exploded view of the coupling device of FIGS. 1-4;

FIG. 4 is a cross-sectional view of the coupling device shown of FIG. 1 taken along the line 4-4 of FIG. 1;

FIG. 5 is a cross-section of the coupling device of FIG. 3 taken along the line 5-5 of FIG. 3; and

FIGS. 6-15 are pictures of one embodiment of the invention.

### DETAILED DESCRIPTION

Refer now to the drawings wherein depicted elements are, for the sake of clarity, not necessarily shown to scale and wherein like or similar elements are designated by the same reference numeral through the several views. Additionally, numerous specific details are set forth to provide a thorough understanding of the present invention. However, it will be obvious to those skilled in the art that the present invention may be practiced without such specific details. In other instances, well-known elements have been illustrated in schematic form in order not to obscure the present invention in unnecessary detail. Furthermore, for the most part, details concerning trusses and the like have been omitted inasmuch as such details are not considered necessary to obtain a complete understanding of the present invention, and are considered to be within the skills of persons of ordinary skill in the relevant art.

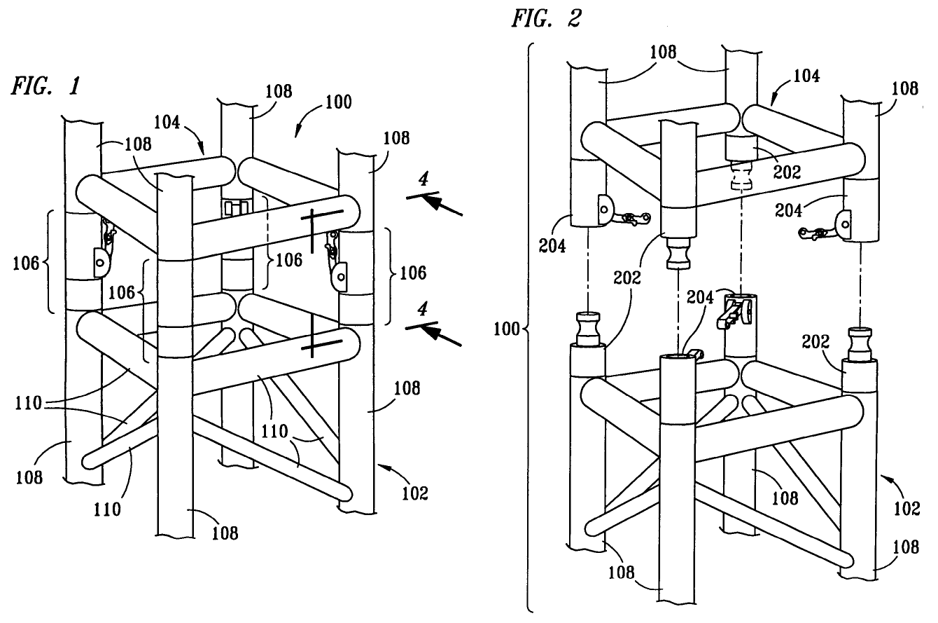

Referring to FIG. 1 of the drawings, the reference numeral 100 generally designates a truss structure having a first truss 102 coupled to a second truss 104 utilizing coupling devices 106 embodying features of the present invention. The trusses 102 and 104 generally constitute conventional trusses having a substantially square cross-section (i.e., in a horizontal plane as viewed in FIG. 1), though they may have other cross-sectional configurations, such as triangular cross-sections, trapezoidal cross-sections, cross-sections having sides of unequal length, and the like. The trusses 102 and 104 may, furthermore, preferably constitute a portion of a larger truss structure, such as are commonly used in the theatrical and entertainment industry, or in scaffolding, where truss structures are assembled for a specific temporary use and then disassembled.

Each of the trusses 102 and 104 comprise four longitudinal tubular members 108 and various lateral members 110 which may be arranged in any of a number of different ways, well known in the art, and therefore will not be discussed in further detail herein, except insofar as necessary to describe the present invention. The trusses 102 and 104 may be fabricated from any suitable material, such as metal (e.g., aluminum, steel), composite materials, and the like.

FIG. 2 depicts the truss structure 100 wherein the trusses 102 and 104 are decoupled from one another. As shown therein, the coupling devices 106 comprise a male coupling portion 202 and a female coupling portion 204. In a truss having a substantially square cross-section, such as the trusses 102 and 104, the arrangement of male and female coupling portions is preferably alternated at each adjacent leg 108 (when there are an even number of legs).

FIG. 3 depicts, in an exploded view of the coupling device 106, various components thereof. Accordingly, the coupling device 106 comprises a male coupling portion 202 configured for matingly engaging a female coupling portion 204. The male coupling portion 202 defines a shank 202a which is configured for fitting into a tubular portion 108 of the first truss 102. An intermediate portion 202b extends from the shank 202a, and preferably defines a larger diameter than the shank 202a. An extension portion 202c extends from the intermediate portion 202b, and preferably defines a smaller diameter than the intermediate portion. A groove 202d is formed in the extension portion 202c, which groove is preferably curvilinear.

The female coupling portion 204 defines a shank 204a which is configured for fitting into a tubular portion 108 of the second truss 104. A receiver end 204b extends from the shank 204a, and defines an opening 204c which is sized for receiving the extension 202c of the male coupling portion 202, as described in further detail below. A lever 302 is configured for being pivotably secured, via a pin 304, to the receiver end 204b, and includes a cam portion 302a configured for engaging the groove 202d, as described in further detail below. The lever 302 preferably also includes a locking mechanism 304, such as is described in U.S. Pat. No. 6,053,540, to Meyer incorporated herein in its entirety by reference. Alternate techniques may be employed to lock the lever 302 in place, such as disclosed in U.S. Pat. Nos. 4,647,075, 4,871,195, and 5,042,850, all of which are incorporated herein by reference in their entireties.

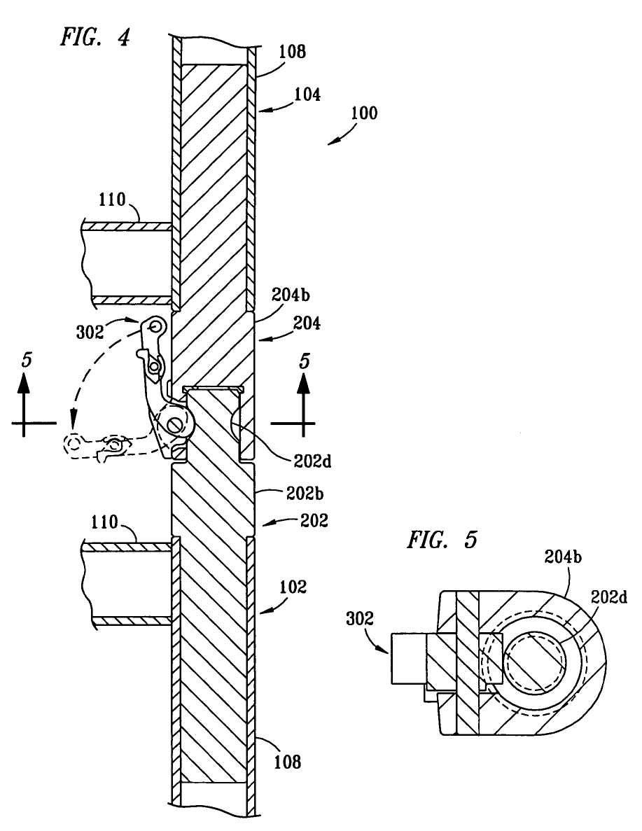

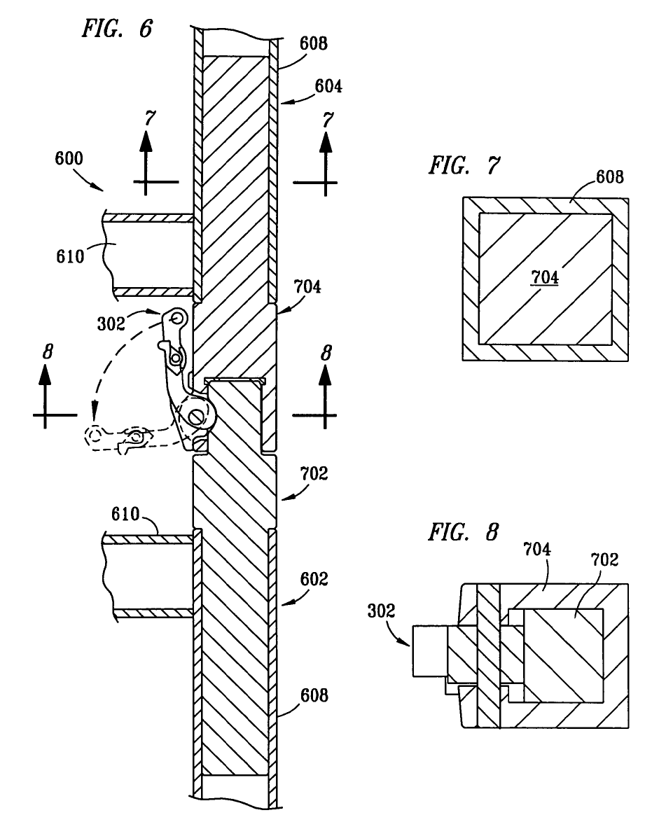

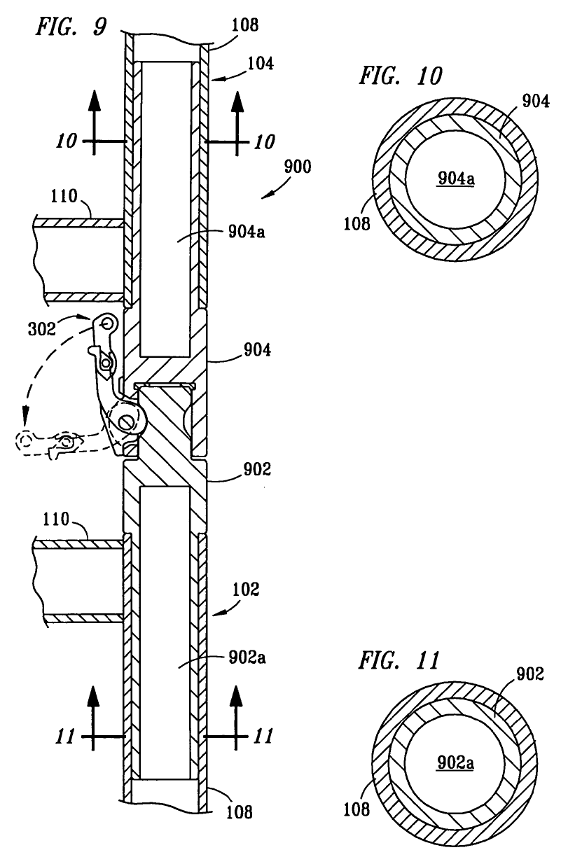

FIG. 4 depicts how the coupling device 106 may be implemented to couple two trusses, it being understand the coupling device and method described herein may be used in any number of trusses, and is not limited to two trusses. As shown therein, the shank 202a of the male coupling portion 202 is fitted in the tubular portion 108 of the first truss 102, and the shank 204a of the female coupling portion 204 is fitted in the tubular portion 108 of the second truss 104, in any of a number of conventional manners, such as by shrink fitting, secured therein by bolts and nuts, and the like. The extension 202c of the male coupling portion 202 is positioned within the opening 204c of the female coupling portion 204. The lever 302 is then rotated to lie adjacent to the receiver end 204b to thereby engage the cam portion 302a with the groove 202d, thereby securing the male coupling portion 202 to the female coupling portion 204. The trusses 202 and 204 may be decoupled by rotating the level 302 away from the receiver end 204b until the cam portion 302a is disengaged from the groove 202d, thereby permitting the male coupling portion 202 to be removed from the female coupling portion 204.

Use of the present invention enables truss structures to be erected much more quickly than is possible using prior art techniques, resulting in substantial monetary savings.

It is understood that the present invention may take many forms and embodiments. Accordingly, several variations may be made in the foregoing without departing from the spirit or the scope of the invention. For example, the groove formed in the male coupling portion may be formed only as needed for enabling the cam member to engage the male coupling portion and secure same in the female coupling portion. The cross-section of the extension 202c may be non-circular, and rather be defined for example by a square cross-section. The male and female coupling portions may have hollow core portions to reduce weight of the coupling device 106. Ball and groove couplings, or pin and groove couplings, may used in place of the cam and groove coupling described herein.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1-5. (canceled)

6. A male coupling comprising:
a shank portion adapted for fitting into at least one tubular member of at least one truss;
an extension portion extending from said shank portion for matingly engaging a receiver portion of at least one female coupling; and
a groove defined about said extension portion for engaging a mechanism mounted to said at least one female coupling for securing said at least one male coupling to said at least one female coupling.

7. The coupling of claim 6, wherein said groove extends through a portion of the circumference of said extension portion.

8. The coupling of claim 6, wherein said groove extends circumferentially about said extension portion.

9. The coupling of claim 6, wherein said tubular members, said shank portion and said extension portion of said male coupling define a substantially circular cross-section.

10. The coupling of claim 6, wherein said tubular members, said shank portion and said extension portion of said male coupling define a substantially square cross-section.

11. The coupling of claim 6, wherein said shank portion of said male coupling defines a hollow interior core portion.

12. A female coupling comprising:
a shank portion adapted for fitting into at least one tubular member of at least one truss;
a receiver portion extending from said shank portion and defining an opening configured for matingly receiving an extension portion of at least one male coupling; and
a mechanism mounted to said at least one female coupling, said mechanism being configured for engaging a groove defined in said extension portion for securing said at least one male coupling to said at least one female coupling.

13. The coupling of claim 12 wherein said mechanism is a cam pivotally mounted to said at least one female coupling.

14. The coupling of claim 12, wherein said mechanism is a cam pivotally mounted to said at least one female coupling, and said cam includes a lever extending therefrom for rotating said cam to engage said cam to said groove and to disengage said cam from said groove.

15. The coupling of claim 12, wherein said mechanism is a cam pivotally mounted to said at least one female coupling, and said cam includes a lever extending therefrom for rotating said cam to engage said cam to said groove and to disengage said cam from said groove, and said lever further includes a locking mechanism for securing said lever in a position so that said cam is urged against said groove to thereby secure said extension portion of said at least one male coupling in said receiver portion of said at least one female coupling.

16. The coupling of claim 12, wherein said at least one tubular member, said shank portion and said receiver portion define a substantially circular cross-section.

17. The coupling of claim 12, wherein said at least one tubular member, said shank portion and said receiver portion define a substantially square cross-section.

18. The coupling of claim 12, wherein said shank portion defines a hollow interior core portion.

19. A first truss comprising:
a plurality of interconnected tubular members;
at least one first male coupling having a shank portion secured into at least one of said plurality of tubular members;
an extension portion extending from said shank portion for matingly engaging a receiver portion of at least one first female coupling secured to a second truss; and
a groove defined about said extension for engaging a mechanism mounted to said at least one first female coupling for securing said at least one first male coupling to said at least one first female coupling.

20. The first truss of claim 19, further comprising:
at least one second female coupling having a shank portion secured into at least one of said plurality of tubular members of said first truss;
a receiver portion extending from said shank portion of said at least one second female coupling and defining an opening configured for matingly receiving an extension portion of at least one second male coupling secured to said second truss;
a mechanism mounted to said at least one second female coupling, said mechanism being configured for engaging a groove defined in said extension portion of said at least one second male coupling for securing said at least one second male coupling to said at least one second female coupling.

21. The first truss of claim 19, wherein:
said at least one first male coupling secured into at least one of said plurality of tubular members of said first truss comprises at least two first male couplings secured into at least two respective corresponding ones of said plurality of tubular members of said first truss;
said at least one first female coupling secured to said second truss comprises at least two first female couplings secured to said second truss; and
said first truss further comprises at least two second female couplings, each of which at least two second female couplings further comprise:
a shank portion secured into a respective corresponding one of said plurality of tubular members of said first truss;
a receiver portion extending from each said shank portion of each of said at least two second female couplings and defining an opening configured for matingly receiving an extension portion of a respective corresponding one of at least two second male couplings secured to said second truss; and
a mechanism mounted to each of said at least two second female couplings, each said mechanism being configured for engaging a groove defined in said extension portion of a respective corresponding one of said at least two second male couplings for securing said at least two second male couplings to said at least two second female couplings.

22. The first truss of claim 19, wherein:
said at least one first male coupling secured into at least one of said plurality of tubular members of said first truss comprises at least two first male couplings secured into at least two respective corresponding ones of said plurality of tubular members of said first truss;
said at least one first female coupling secured to said second truss comprises two first female couplings secured to said second truss; and
said first truss further comprises two second female couplings, each of which two second female couplings comprises:
a shank portion secured into a respective corresponding one of said plurality of tubular members of said first truss;
a receiver portion extending from each said shank portion of each of said two second female couplings and defining an opening configured for matingly receiving an extension portion of a respective corresponding one of two second male couplings secured to said second truss;
a mechanism mounted to each of said two second female couplings, each said mechanism being configured for engaging a groove defined in said extension portion of a respective corresponding one of said two second male couplings for securing said two second male couplings to said two second female couplings, wherein said two first male couplings and said two second female couplings are alternately distributed about said first truss.

23. A first truss comprising:
a plurality of interconnected tubular members;
at least one female coupling having a shank secured into at least one of said plurality of tubular members;
a receiver extending from said shank and defining an opening configured for matingly receiving an extension of at least one male coupling secured to a second truss; and
a mechanism mounted to said at least one female coupling, said mechanism being configured for engaging a groove defined in said extension for securing said at least one male coupling to said at least one female coupling.

24. The truss of claim 23 wherein said mechanism is a cam pivotally mounted to said at least one female coupling.

25. The truss of claim 23, wherein said mechanism is a cam pivotally mounted to said at least one female coupling, and said cam includes a lever extending therefrom for rotating said cam to engage said cam with said groove and to disengage said cam from said groove.

26. The truss of claim 23, wherein said mechanism is a cam pivotally mounted to said at least one female coupling, and said cam includes a lever extending therefrom for rotating said cam to engage said cam with said groove and to disengage said cam from said groove, and said lever further includes a locking mechanism for securing said lever in a position so that said cam is urged against said groove to thereby secure said extension portion of said at least one male coupling in said receiver portion of said at least one female coupling.

27. A method for making a male coupling, comprising steps of:
forming a shank portion of said male coupling for fitting into at least one tubular member of at least one truss;
forming an extension portion of said male coupling, said extension portion extending from said shank for matingly engaging a receiver portion of at least one female coupling; and
forming a groove about said extension for engaging a mechanism mounted to said at least one female coupling for securing said at least one male coupling to said at least one female coupling.

28. The method of claim 27, wherein the step of forming said groove further comprises forming said groove through at least a portion of the circumference of said extension portion.

29. The method of claim 27, wherein the step of forming said groove further comprises forming said groove circumferentially around said extension portion.

30. The method of claim 27, wherein said at least one tubular member defines a substantially circular cross-section, and the step of forming said shank portion further comprises forming said shank to define a substantially circular cross-section, said the step of forming said extension portion further comprises forming said extension portion to define a substantially circular cross-section.

31. The method of claim 27, wherein said at least one tubular member defines a substantially circular cross-section, and the step of forming said shank portion further comprises forming said shank to define a substantially square cross-section, said the step of forming said extension portion further comprises forming said extension portion to define a substantially square cross-section.

32. The method of claim 27, further comprising the step of forming a hollow interior core portion in said shank portion of said male coupling.

33. A method for making a female coupling, comprising steps of:
forming a shank portion for fitting into at least one tubular member of at least one truss;
forming a receiver portion extending from said shank portion and defining an opening configured for matingly receiving an extension portion of at least one male coupling; and
mounting a mechanism to said at least one female coupling, said mechanism being configured for engaging a groove defined in said extension portion for securing said at least one male coupling to said at least one female coupling.

34. The method of claim 33, wherein said mechanism is a cam, and the step of mounting further comprises pivotally mounting said cam to said at least one female coupling.

35. The method of claim 33, wherein said mechanism is a cam, and the step of mounting further comprises pivotally mounting said cam to said at least one female coupling, and said cam includes a lever extending therefrom for rotating said cam to engage said cam to said groove and to disengage said cam from said groove.

36. The method of claim 33, wherein said mechanism is a cam, and the step of mounting further comprises pivotally mounting said cam to said at least one female coupling, and said cam includes a lever extending therefrom for rotating said cam to engage said cam to said groove and to disengage said cam from said groove, and said lever further includes a locking mechanism for securing said lever in a position so that said cam is urged against said groove to thereby secure said extension portion of said at least one male coupling in said receiver portion of said at least one female coupling.

37. The method of claim 33, wherein said at least one tubular member defines a substantially circular cross-section, and the step of forming a shank portion further comprises forming a shank portion having a substantially circular cross section, and the step of forming a receiver portion further comprises forming a receiver portion having a substantially circular cross section.

38. The method of claim 33, wherein said at least one tubular member defines a substantially circular cross-section, and the step of forming a shank portion further comprises forming a shank portion having a substantially square cross section, and the step of forming a receiver portion further comprises forming a receiver portion having a substantially square cross section.

39. The method of claim 33, further comprising the step of forming a hollow interior core portion in said shank portion of said female coupling.

40. A method for assembling a first truss comprising a step of securing a shank portion of at least one male coupling into one of at least two interconnected tubular members of said first truss, said at least one male coupling further having an extension portion extending from said shank portion for matingly engaging a receiver portion of at least one female coupling secured to a second truss, and a groove defined about said extension portion for engaging a mechanism mounted to said at least one female coupling for securing said at least one male coupling to said at least one female coupling.

41. The method of claim 40, further comprising the step of securing a shank portion of at least one second female coupling into one of said at least two tubular members of said first truss, said second female coupling further comprising a receiver portion extending from said shank portion of said at least one second female coupling and defining an opening configured for matingly receiving an extension portion of at least one second male coupling secured to said second truss, and a mechanism mounted to said at least one second female coupling for engaging a groove defined in said extension portion of said at least one second male coupling for securing said at least one second male coupling to said at least one second female coupling.

42. The method of claim 40, wherein:
said at least two interconnected tubular members of said first truss comprise at least four interconnected tubular members;
the step of securing a shank portion of at least one first male coupling into at least two tubular members of said first truss, further comprises securing a shank portion of each of at least two first male couplings into a respective corresponding one of said at least four tubular members of said first truss;
said at least one first female coupling secured to said second truss comprises at least two first female couplings secured to said second truss; and
the method further comprises securing a shank portion of each of at least two second female couplings into a respective corresponding one of said at least four tubular members of said first truss, each of which at least two second female couplings further comprise:
a receiver portion extending from each said shank portion of each of said at least two second female couplings and defining an opening configured for matingly receiving an extension portion of a respective corresponding one of at least two second male couplings secured to said second truss; and
a mechanism mounted to each of said at least two second female couplings, each said mechanism being configured for engaging a groove defined in said extension portion of a respective corresponding one of said at least two second male couplings for securing said at least two second male couplings to said at least two second female couplings.

43. The method of claim 40, wherein:
said at least two interconnected tubular members of said first truss comprise at least four interconnected tubular members;
the step of securing a shank portion of at least one first male coupling into one of at least two tubular members of said first truss, further comprises securing a shank portion of each of at least two first male couplings into a respective corresponding one of said at least four tubular members of said first truss;
said at least one first female coupling secured to said second truss comprises at least two first female couplings secured to said second truss; and
the method further comprises securing a shank portion of at least two second female couplings into a respective corresponding one of said at least two tubular members of said first truss, each of which at least two second female couplings further comprise:
a receiver portion extending from each said shank portion of each of said at least two second female couplings and defining an opening configured for matingly receiving an extension portion of a respective corresponding one of at least two second male couplings secured to said second truss; and
a mechanism mounted to each of said at least two second female couplings, each said mechanism being configured for engaging a groove defined in said extension portion of a respective corresponding one of said at least two second male couplings for securing said at least two second male couplings to said at least two second female couplings, wherein said two first male couplings and said two second female couplings are alternately distributed about said first truss.

44. A method for assembling a first truss comprising a step of securing a shank portion of at least one female coupling into at least one tubular member of said first truss, said at least one female coupling further having a receiver extending from said shank and defining an opening configured for matingly receiving an extension of at least one male coupling secured to a second truss, and a mechanism mounted to said at least one female coupling, said mechanism being configured for engaging a groove defined in said extension for securing said at least one male coupling to said at least one female coupling.

45. The method of claim 44 wherein said mechanism is a cam pivotally mounted to said at least one female coupling.

46. The method of claim 44, wherein said mechanism is a cam pivotally mounted to said at least one female coupling, and said cam includes a lever extending therefrom for rotating said cam to engage said cam with said groove and to disengage said cam from said groove.

47. The method of claim 44, wherein said mechanism is a cam pivotally mounted to said at least one female coupling, and said cam includes a lever extending therefrom for rotating said cam to engage said cam with said groove and to disengage said cam from said groove, and said lever further includes a locking mechanism for securing said lever in a position so that said cam is urged against said groove to thereby secure said extension portion of said at least one male coupling in said receiver portion of said at least one female coupling.

48. A method for coupling together a first truss to a second truss,
said first truss comprising:
a plurality of first interconnected tubular members;
at least one first male coupling having a shank portion secured into at least one of said plurality of first tubular members;
an extension portion extending from said shank portion for matingly engaging a receiver portion of at least one first female coupling secured to said second truss; and
a groove defined about said extension portion for engaging a mechanism mounted to said at least one first female coupling, said mechanism being configured for securing said at least one first male coupling to said at least one first female coupling;
said second truss comprising:
a plurality of second interconnected tubular members;
said at least one female coupling having a shank portion secured into at least one of said plurality of second tubular members;
a receiver portion extending from said shank portion and defining an opening configured for matingly receiving said extension portion of said at least one male coupling secured to said second truss; and
a mechanism mounted to said at least one female coupling, said mechanism being configured for engaging said groove defined in said extension for securing said at least one male coupling to said at least one female coupling; and
said method comprises steps of:
inserting said extension portion of said male coupling into said receiver portion of said female coupling; and
actuating said mechanism to engage said groove to thereby secure said at least one male coupling to said at least one female coupling, and said first truss to said second truss.

49. The method of claim 48, wherein said mechanism is a cam pivotally mounted to said at least one female coupling.

50. The method of claim 48, wherein said mechanism is a cam pivotally mounted to said at least one female coupling, said cam having a lever extending therefrom, and the step of actuating further comprises the step of rotating said lever to rotate said cam to urge said cam against said groove.

51. The method of claim 48, wherein said mechanism is a cam pivotally mounted to said at least one female coupling, said cam having an engagement lever extending therefrom, said engagement lever having a locking mechanism, and the step of actuating further comprises steps of rotating said lever to rotate said cam to engage and urge said cam against said groove, and actuating said locking mechanism to secure engagement of said cam in said groove.

52. A method for coupling a first truss to a second truss, each of said first truss and said second truss being fabricated from respective tubular members interconnected together, the method comprising steps of:
securing a shank portion of at least one male coupling into at least one tubular member of said first truss, said at least one male coupling having an extension portion extending from said shank portion and defining a groove therein;
fitting a shank portion of at least one female coupling into at least one tubular member of said second truss, said at least one female coupling having a receiver portion defining an opening configured for matingly receiving said extension portion of said at least one male coupling;
inserting said extension portion of said at least one male coupling into said receiver portion of a matingly corresponding one of said at least one female coupling; and
rotating a lever pivotably mounted on each said at least one female coupling so that a cam portion of said lever engages said groove of said extension portion of a matingly corresponding one of said at least one male coupling and secures each said at least one male coupling to each said at least one female coupling.

53. The method of claim 52, further comprising the step of actuating a locking mechanism for securing said lever in a position so that said cam portion of said lever is urged against said groove to thereby secure said at least one male coupling in said at least one female coupling.

54. The method of claim 52, further comprising the steps of securing a shank portion of at least one male coupling into at least one tubular member of said second truss; and securing a shank portion of at least one female coupling into at least one tubular member of said first truss, such that an equal number of said at least one male coupling and said at least one female coupling are fitted on said at least one tubular member of said first truss and on said at least one tubular member of said second truss.

55. The method of claim 52, further comprising the steps of securing a shank portion of at least one male coupling into at least one tubular member of said second truss; and securing a shank portion of at least one female coupling into at least one tubular member of said first truss, such that said at least one male coupling and said at least one female coupling are alternately distributed on said at least one tubular member of said first truss and on said at least one tubular member of said second truss.
